(19) United States
(12) Patent Application Publication
(10) Pub. No.: US 2010/0134036 A1
(43) Pub. Date: Jun. 3, 2010

(54) TRANSFORMER AND BACKLIGHT APPARATUS

(75) Inventors: Hung Te Chang, Taoyuan County (TW); Ming Yen Wu, Taoyuan County (TW); Heng Wen Chen, Taoyuan County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/476,986

(22) Filed: Jun. 2, 2009

(30) Foreign Application Priority Data
Dec. 2, 2008 (TW) 097221585

(51) Int. Cl. H05B 41/14; H01F 27/40

(52) U.S. Cl. 315/276; 336/69

(57) ABSTRACT

The invention discloses a transformer and a backlight apparatus. The backlight apparatus includes a power module, a lamp and a transformer. The transformer includes a bobbin, a primary winding, a secondary winding, a first conductive plate and a second conductive plate. The bobbin has a high-voltage winding region and a pin. The primary winding is coupled to the power module. The secondary winding is wound on the high-voltage winding region and one end of the secondary winding is electrically connected to the pin, which is further coupled to the lamp of the backlight apparatus. A separation plate is disposed on the high-voltage winding region. The first conductive plate is disposed in the separation plate and electrically connected to the pin. The second conductive plate is disposed in the separation plate and located corresponding to the first conductive plate. Accordingly, the first conductive plate and the second conductive plate form a capacitor.

### BACKGROUND OF THE INVENTION

1. Field of the Invention

The invention relates to a transformer and a backlight apparatus. More particularly, the invention relates to a transformer with a built-in protective capacitor and a backlight apparatus with this transformer structure.

2. Description of the Prior Art

In recent years, along with the gradually enlarged size of the liquid crystal display panel, the backlight apparatus comprising a plurality of Cold Cathode Fluorescent Lamps (CCFL) is widely utilized to provide the high quality light source needed in the liquid crystal display panel. Each lamp's brightness of the multi-lamp backlight apparatus is related to the current flow through said lamp. Therefore, the design issues of the multi-lamp backlight apparatus include how to maintain the currents through all lamps equally, and how to prevent unbalanced occurrences among the lamps. Additionally, the protective function for the circuit of the multi-lamp backlight apparatus under some faulty conditions (e.g. short circuit, open circuit) becomes a critical issue in the multi-lamp backlight system as well.

In the traditional backlight system, the high-voltage output of the transformer is usually coupled to a high-voltage capacitor on the circuit board. The high-voltage capacitor is used to adjust the output signal of the transformer. Furthermore, the high-voltage capacitor can be connected in series with another capacitor or a resistor to form a voltage-dividing circuit, which is one part of the protective circuit.

Please refer to FIG. 1. FIG. 1 is a schematic diagram illustrating a backlight apparatus 1 in prior art. As shown in FIG. 1, the backlight apparatus 1 includes power module 10, at least one lamp 12 and a transformer 14. In FIG. 1, an example is demonstrated including the one-to-one transformer 14 and one singular lamp 12.

The transformer 14, driven by the power module 10, is used to push the load (lamp 12). The high-voltage side of the transformer 14 is coupled to the lamp 12 and a capacitor 16. The capacitor 16 is further connected in series with another passive component 18 (which can be a resistor or a capacitor). The capacitor 16 and the passive component 18 form a voltage-dividing circuit. The voltage-dividing circuit can generate the feedback input for the protective feedback circuit 20.

Please refer to FIG. 2. FIG. 2 is a schematic diagram illustrating the backlight apparatus 1 and the transformer 14 in FIG. 1. As shown in FIG. 2, the transformer 14 includes a bobbin 140, a primary winding 142 and a secondary winding 144. The primary winding 142 is coupled to the power module 10. The secondary winding 144 is wound on a high-voltage winding region 1402 of the bobbin 140. One end of the secondary winding 144 is electrically connected to the lamp 12 and the capacitor 16. The capacitor 16, the passive component 18 and the protective feedback circuit 20 forms the feedback structure with voltage-dividing circuit including the high-voltage capacitor in prior art.

As shown in FIG. 1, in a traditional backlight apparatus, a capacitor must be implemented on the output side of the transformer. If the transformer is a one-to-four transformer, it must implement at least four capacitors as part of the protective circuit cooperating with the one-to-four transformer. However, with the ever-improving manufacturing process, the scale of circuit is getting more compacted. To implement several capacitors on the circuit board to cooperate with the transformer is inefficient in the on-chip area allocation.

Therefore, the invention discloses a transformer and a backlight apparatus utilizing the transformer, to solve the said problems.

### SUMMARY OF THE INVENTION

A scope of the invention is to provide a transformer. The transformer is suitable for a backlight module with a first lamp. The transformer includes a bobbin, a secondary winding, a first conductive plate and a second conductive plate.

According to an embodiment of the invention, the bobbin has a high-voltage winding region and a first pin thereon. The secondary winding is wound on the high-voltage winding region. One end of the secondary winding is electrically connected to the first pin. The first pin is coupled to the first lamp of the backlight module. The high-voltage winding region has a first separation plate. The first conductive plate is disposed within the first separation plate. The first conductive plate is electrically connected to the first pin. The second conductive plate is disposed within the first separation plate. The second conductive plate is located corresponding to the first conductive plate, such that the first conductive plate and the second conductive plate form a first capacitor.

Another scope of the invention is to provide a transformer. The transformer is suitable for a backlight module with a first lamp and a second lamp. The transformer includes a bobbin, a first secondary winding, a second secondary winding, a first conductive plate, a second conductive plate, a third conductive plate and a fourth conductive plate.

According to another embodiment of the invention, the bobbin has a first high-voltage winding region, a second high-voltage winding region, a first pin and a second pin thereon. The first secondary winding is wound on the first high-voltage winding region. One end of the first secondary winding is electrically connected to the first pin. The first pin is coupled to the first lamp of the backlight module. The second secondary winding is wound on the second high-voltage winding region. One end of the second secondary winding is electrically connected to the second pin. The second pin is coupled to the second lamp of the backlight module. The first high-voltage winding region has a first separation plate. The first conductive plate is disposed within the first separation plate. The first conductive plate is electrically connected to the first pin. The second conductive plate is disposed within the first separation plate. The second conductive plate is located corresponding to the first conductive plate, such that the first conductive plate and the second conductive plate form a first capacitor. The second high-voltage winding region has a second separation plate. The third conductive plate is disposed within the second separation plate. The third conductive plate is electrically connected to the second pin. The fourth conductive plate is disposed within the second separation plate. The fourth conductive plate is located corresponding to the third conductive plate, such that the third conductive plate and the fourth conductive plate form a second capacitor.

Another scope of the invention is to provide a backlight apparatus. The backlight apparatus includes a power module, a first lamp and a transformer. The transformer includes a bobbin, a primary winding, a secondary winding, a first conductive plate and a second conductive plate.

According to another embodiment of the invention, the bobbin has a low-voltage winding region, a high-voltage winding region and a first pin thereon. The primary winding is wound on the low-voltage winding region. The primary winding is coupled to the power module. The secondary winding is wound on the high-voltage winding region. One end of the secondary winding is electrically connected to the first pin. The first pin is coupled to the first lamp of the backlight apparatus. The high-voltage winding region has a first separation plate. The first conductive plate is disposed within the first separation plate. The first conductive plate is electrically connected to the first pin. The second conductive plate is disposed within the first separation plate. The second conductive plate is located corresponding to the first conductive plate, such that the first conductive plate and the second conductive plate form a first capacitor.

Another scope of the invention is to provide a backlight apparatus. The backlight apparatus includes a power module, a first lamp, a second lamp and a transformer. The transformer includes a bobbin, a primary winding, a first secondary winding, a second secondary winding, a first conductive plate, a second conductive plate, a third conductive plate and a fourth conductive plate.

According to another embodiment of the invention, the bobbin has a low-voltage winding region, a first high-voltage winding region, a second high-voltage winding region, a first pin and a second pin thereon. The primary winding is wound on the low-voltage winding region. The primary winding is coupled to the power module. The first secondary winding is wound on the first high-voltage winding region. One end of the first secondary winding is electrically connected to the first pin. The first pin is coupled to the first lamp of the backlight apparatus. The second secondary winding is wound on the second high-voltage winding region. One end of the second secondary winding is electrically connected to the second pin. The second pin is coupled to the second lamp of the backlight apparatus. The first high-voltage winding region has a first separation plate. The first conductive plate is disposed within the first separation plate. The first conductive plate is electrically connected to the first pin. The second conductive plate is disposed within the first separation plate. The second conductive plate is located corresponding to the first conductive plate, such that the first conductive plate and the second conductive plate form a first capacitor. The second high-voltage winding region has a second separation plate. The third conductive plate is disposed within the second separation plate. The third conductive plate is electrically connected to the second pin. The fourth conductive plate is disposed within the second separation plate. The fourth conductive plate is located corresponding to the third conductive plate, such that the third conductive plate and the fourth conductive plate form a second capacitor.

Compared with prior art, there are at least two conductive plates disposed within the bobbin of the transformer according to the embodiment of the backlight apparatus of the invention. The conductive plates are parallel-arranged and separated by a certain distance, such that a capacitance effect exists between the pair of conductive plates. The conductive plates can be coupled to the high-voltage side of the transformer and can serve as the protective capacitor of the circuit of the backlight apparatus. Accordingly, the transformer and the backlight apparatus of the invention can be implemented with this low-cost and compact-sized circuit structure.

The advantage and spirit of the invention may be understood by the following recitations together with the appended drawings.

### BRIEF DESCRIPTION OF THE APPENDED DRAWINGS

FIG. 1 is a schematic diagram illustrating a backlight apparatus in prior art.

FIG. 2 is a schematic diagram illustrating the backlight apparatus and the transformer in FIG. 1.

FIG. 3 is a schematic diagram illustrating a backlight apparatus and a transformer adopted by the backlight apparatus according to the first embodiment of the invention.

FIG. 4 is a schematic diagram illustrating a backlight apparatus and a transformer adopted by the backlight apparatus according to another embodiment of the invention.

FIG. 5 is a schematic diagram illustrating a backlight apparatus and a transformer adopted by the backlight apparatus according to the second embodiment of the invention.

FIG. 6 is a schematic diagram illustrating a backlight apparatus and a transformer adopted by the backlight apparatus according to the third embodiment of the invention.

FIG. 7 is a schematic diagram illustrating a backlight apparatus and a transformer adopted by the backlight apparatus according to the fourth embodiment of the invention.

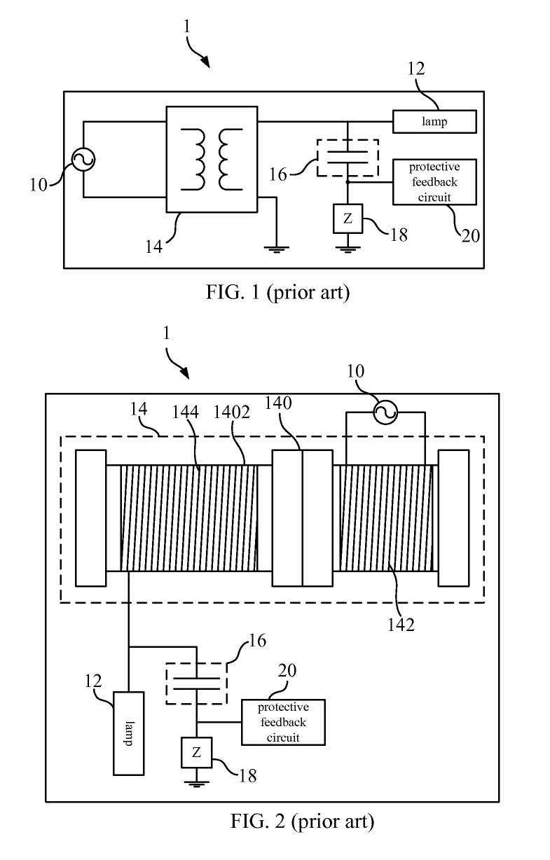

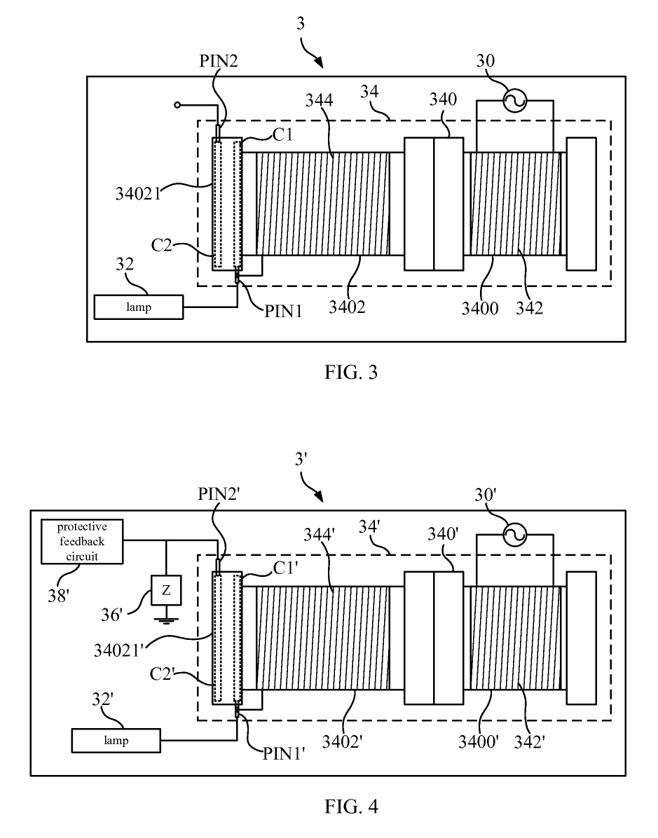

### DETAILED DESCRIPTION OF THE INVENTION

Please refer to FIG. 3. FIG. 3 is a schematic diagram illustrating a backlight apparatus 3 and a transformer 34 adopted by the backlight apparatus 3 according to the first embodiment of the invention. As shown in FIG. 3, the backlight apparatus 3 includes a power module 30, a lamp 32 and a transformer 34. The transformer 34 includes a bobbin 340, a primary winding 342, a secondary winding 344, a conductive plate C1 and another conductive plate C2. It is important to notice that the transformer 34 in the embodiment is not limited to this particular structure of the backlight apparatus 3. The transformer 34 can cooperate with various kinds of the backlight modules or be implemented in some other electronic devices in practical applications.

In practical applications, the main body of the transformer 34 is the bobbin 340. The bobbin 340 is used to support the windings and accommodating the magnetic core. The bobbin can be made of an isolating material, e.g. Nylon, Polyethylene terephthalate (PET). Generally, there can be some separation plates disposed on the bobbin 340 for defining different winding regions.

In the embodiment, the bobbin 340 has a low-voltage winding region 3400, a high-voltage winding region 3402, a pin PIN1 and another pin PIN2. The primary winding 342 is wound on the low-voltage winding region 3400 and coupled to the power module 30. The secondary winding 344 is wound on the high-voltage winding region 3402. One end of the secondary winding 344 is electrically connected to the pin PIN1. The pin PIN1 is further coupled to the lamp 32 of the backlight apparatus 3.

There is a specific ratio between the turn numbers of the primary winding 342 and the secondary winding 344. Based on the electromagnetic induction, the primary winding 342 driven by the power module 30 induces the secondary winding 344 on the same magnetic loop, therefore, the induced secondary winding 344 generates an induced output for driving the lamp 32. In other words, the transformer 34 in the embodiment can be the one-to-one transformer for driving one singular load. Besides, the backlight apparatus 3 in the embodiment includes singular one-to-one transformer 34, which can correspond to singular lamp 32. In practical applications, the backlight apparatus may include multiple transformers at the same time, for corresponding to more lamps at once. In other words, the amount of the transformers in the backlight apparatus is not limited to one. The structure with multiple transformers is known by the person skilled in the art.

As shown in FIG. 3, the high-voltage region 3402 has a separation plate 34021. The conductive plate C1 and the conductive plate C2 are disposed within the separation plate 34021. The conductive plate C1 is electrically connected to the pin PIN1 and coupled to the lamp 32. The conductive plate C2 is electrically connected to the pin PIN2.

The conductive plate C2 is disposed at the location corresponding to the conductive plate C1. The conductive plate C1 and the conductive plate C2 are made of conductive material, which can be metal material. According to the theory of plate capacitor, an equivalent capacitor can be formed between these two metal plates (the conductive plates C1, C2), which are separated by a certain distance and opposite disposed within the dielectric body (the separation body 34021).

The capacitance of the capacitor can be designed by adjusting the specification of the conductive plates C1, C2. For example, the capacitance of a plate capacitor, which is formed by two parallel conductive plates in identical size, is about εA/d (when A>>d²), wherein “ε” represents the dielectric index of the dielectric material (separation plate 34021); “A” represents the area of the conductive plate; “d” represents the distance between two conductive plates (conductive plate C1 and conductive plate C2). Accordingly, the two conductive plates disposed within the separation plate on the high-voltage side of the transformer can serve as a built-in capacitor, to save the extra costs and space of implementing the additional high-voltage capacitor on the circuit board.

It should be noticed that, in the first embodiment, when the built-in capacitor are equivalently formed by the conductive plate C1 and the conductive plate C2, the pin PIN2 electrically connected with the conductive plate C2 can be an open circuit (as shown in FIG. 3). In practical application, the pin PIN2 can be further connected to components on the circuit board. In other words, the pin PIN2 can be an input terminal for other functions in the transformer, for example, the pin PIN2 can be utilized in the protective feedback function.

Please refer to FIG. 4. FIG. 4 is a schematic diagram illustrating a backlight apparatus 3′ and a transformer 34′ adopted by the backlight apparatus 3′ according to another embodiment of the invention. The main difference between the backlight apparatus 3′ and the backlight apparatus in the first embodiment is that the backlight apparatus 3′ further includes a passive component 36′ and a protective feedback circuit 38′. The pin PIN2′, not an open circuit in this embodiment, is coupled to the passive component 36′ and the protective feedback circuit 38′. As shown in FIG. 4, the pin PIN2′, electrically connected with the passive component 36′, is coupled to the ground through the passive component 36′. The protective feedback circuit 38′ is electrically connected between the pin PIN2 and the passive component 36′.

The passive component 36′ can be a resistor, a capacitor or an inductor. The passive component 36′ is connected in series with the built-in capacitor formed by the conductive plates C1, C2 in the transformer 34′, to form a voltage-dividing circuit. The voltage-dividing output of the voltage-dividing circuit can be designed by adjusting the size of the conductive plates, the distance between the conductive plates or the index of the passive component 36′ on the circuit board. The voltage-dividing output of the voltage-dividing circuit is used for feed back to the input stage of the protective feedback circuit 38′, so as to achieve the protective function for the transformer circuit. The behavior of the voltage-dividing circuit and the protective feedback circuit 38′ is similar to one of the feedback structure with voltage-dividing circuit including the high-voltage capacitor in prior art. The theory of the feedback structure in prior art is well known by the person skilled in the art, and is not repeated here.

It is important to notice that the backlight apparatus 3′ does not need to implement the additional high-voltage capacitor on the circuit board. The transformer 34′ utilizes two conductive plates disposed within the separation plate on the high-voltage side, to serve as the built-in capacitor on the high-voltage side of the transformer 34′. Accordingly, it saves the extra space of implementing the additional high-voltage capacitor on the circuit board.

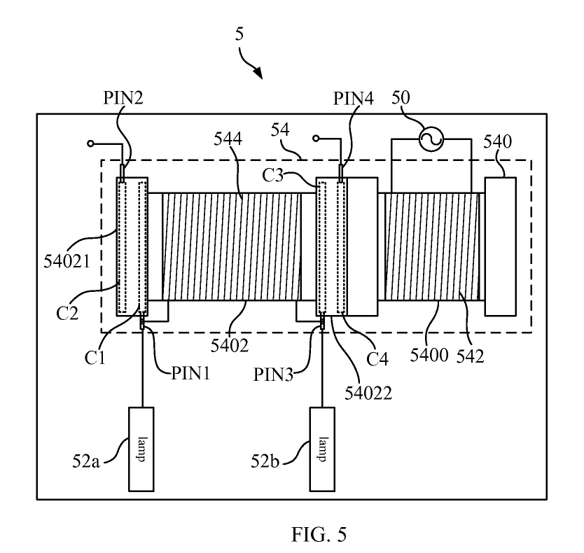

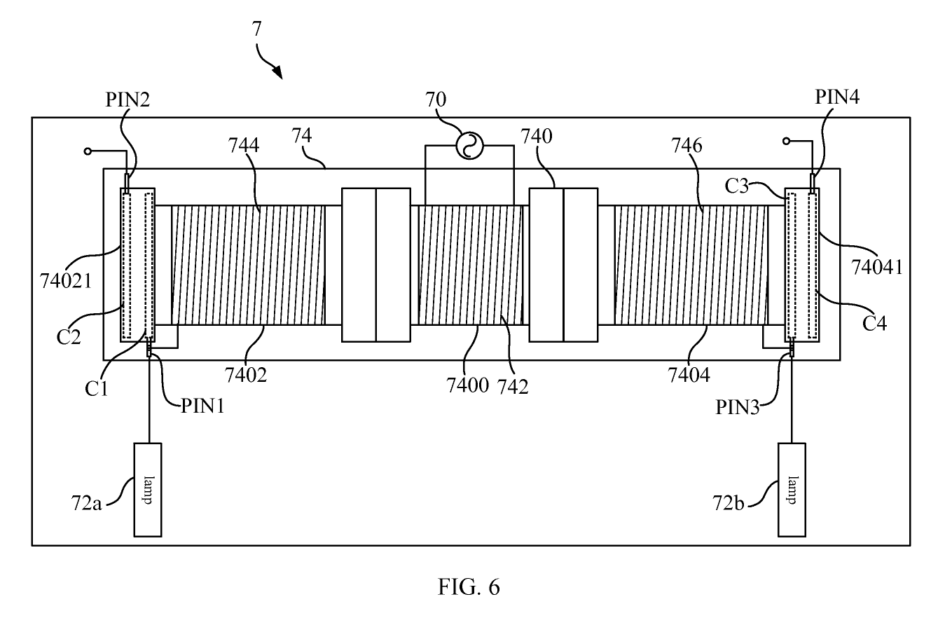

Please refer to FIG. 5. FIG. 5 is a schematic diagram illustrating a backlight apparatus 5 and a transformer 54 adopted by the backlight apparatus 5 according to the second embodiment of the invention. The main difference from the first embodiment is that the backlight apparatus 5 in the second embodiment is a one-to-two backlight apparatus, which is designed for driving two lamps (lamp 52a, lamp 52b) at the same time. The transformer 54 of the backlight apparatus 5 further includes a conductive plate C3 and a conductive plate C4. In other words, the transformer 54 includes a total of four conductive plates (i.e. conductive plate C1, conductive plate C2, conductive plate C3 and conductive plate C4). As shown in FIG. 5, the conductive plate C3 and the conductive plate C4 are disposed within a separation plate 54022 on the high-voltage winding region 5402 in pair.

In this embodiment, the bobbin 540 further includes a pin PIN3 and a pin PIN4. The conductive plate C3 is electrically connected with the pin PIN3. The pin PIN3 is electrically connected to one end of the secondary winding 544 and coupled to the lamp 52b. The conductive plate C4 is electrically connected to the pin PIN4. The pin PIN4 can be an open circuit (as shown in FIG. 5), or in another embodiment, the pin PIN4 can be further coupled to a passive component and a protective feedback circuit of the backlight apparatus. In other words, the pin PIN4 can serve as a voltage-dividing input stage for the protective feedback structure. The connection pattern for the voltage-dividing circuit and other detail structures of the backlight apparatus 5 are similar to aforesaid embodiment, and are not repeated here.

Based on the aforesaid structure, the conductive plate C3 and the conductive plate C4 are disposed in pair to form a capacitor. This means that on the high-voltage side of the transformer 54, there are two pairs of the conductive plates. One pair of the conductive plate C1 and the conductive plate C2 corresponds to the lamp 52a. Another pair of the conductive plate C3 and the conductive plate C4 corresponds to the lamp 52b. Accordingly, the one-to-two transformer 54 and backlight apparatus 5 with the built-in protective capacitors are formed.

Please refer to FIG. 6. FIG. 6 is a schematic diagram illustrating a backlight apparatus 7 and a transformer 74 adopted by the backlight apparatus 7 according to the third embodiment of the invention. The transformer 74 is a one-to-two transformer, which is used for driving two lamps at the same time.

The backlight apparatus 7 includes a power module 70, a lamp 72a, a lamp 72b and a transformer 74. The transformer 74 includes a bobbin 740, a primary winding 742, a first secondary winding 744, a second secondary winding 746, a conductive plate C1, a conductive plate C2, a conductive plate C3 and a conductive plate C4.

In the embodiment, the bobbin 740 has a low-voltage winding region 7400, a first high-voltage winding region 7402, a second high-voltage winding region 7404, a pin PIN1, a pin PIN2, a pin PIN3 and a pin PIN4. The primary winding 742 is wound on the low-voltage winding region 7400. The primary winding 742 is coupled to the power module 70.

The first secondary winding 744a is wound on the first high-voltage winding region 7402. One end of the first secondary winding 744 is electrically connected to the pin PIN1. The pin PIN1 is coupled to the lamp 72a of the backlight apparatus 7.

The first high-voltage winding region 7402 has a separation plate 74021. The conductive plate C1 and the conductive plate C2 are disposed within the separation plate 74021. The conductive plate C1 is electrically connected to the pin PIN1 and further coupled to the lamp 72a. The conductive plate C2 is electrically connected to the pin PIN2. The conductive plate C2 is disposed at the location corresponding to the conductive plate C1. The conductive plate C1 and the conductive plate C2 can be made of metal material. According to the theory of plate capacitor, an equivalent capacitor can be formed between the conductive plate C1 and the conductive plate C2.

The second secondary winding 746 is wound on the second high-voltage winding region 7404. One end of the second secondary winding 746 is electrically connected to the pin PIN3. The pin PIN3 is coupled to the lamp 72b of the backlight apparatus 7.

The second high-voltage winding region 7404 has a separation plate 74041. The conductive plate C3 and the conductive plate C4 are disposed within the separation plate 74041. The conductive plate C3 is electrically connected to the pin PIN3. The conductive plate C4 is disposed at the location corresponding to the conductive plate C3. The conductive plate C3 and the conductive plate C4 can be made of metal material. According to the theory of plate capacitor, an equivalent capacitor can be formed between the conductive plate C3 and the conductive plate C4.

Based on the aforesaid structure, on the high-voltage side of the transformer 74, there are two pairs of the conductive plates. One pair of the conductive plate C1 and the conductive plate C2 corresponds to the lamp 72a. Another pair of the conductive plate C3 and the conductive plate C4 corresponds to the lamp 72b. Accordingly, the one-to-two transformer 74 and backlight apparatus 7 with the built-in protective capacitors are formed.

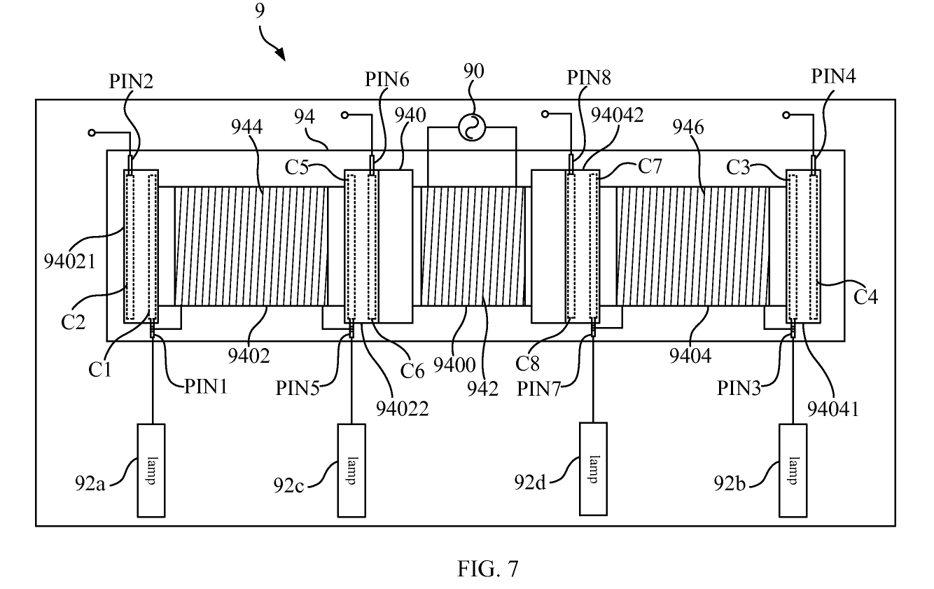

Please refer to FIG. 7. FIG. 7 is a schematic diagram illustrating a backlight apparatus 9 and a transformer 94 adopted by the backlight apparatus 9 according to the fourth embodiment of the invention. Compared with the third embodiment, the transformer 94 is a one-to-four transformer, which is used for driving four lamps (lamp 92a, lamp 92b, lamp 92c and lamp 92d) at the same time.

Compared with the backlight apparatus 7 in the third embodiment, the transformer 94 of the backlight apparatus 9 further includes a conductive plate C5, a conductive plate C6, a conductive plate C7 and a conductive plate C8. In other words, the transformer 94 totally includes eight conductive plates. As shown in FIG. 7, the conductive plate C5 and the conductive plate C6 are disposed within a separation plate 94022 on a second high-voltage winding region 9402 in pair; the conductive plate C7 and the conductive plate C8 are disposed within a separation plate 94042 on a second high-voltage winding region 9404 in pair. Other detailed structures of the backlight apparatus 9 are similar to aforesaid embodiment, and are not repeated here.

In this embodiment, the conductive plate C5 and the conductive plate C6 are disposed in pair to form a capacitor corresponding to the lamp 92c, and the conductive plate C7 and the conductive plate C8 are disposed in pair to form a capacitor corresponding to the lamp 92d. That is to say, on the high-voltage side of the transformer 94, there are four pairs of the conductive plates (conductive plate C1 and conductive plate C2, conductive plate C3 and conductive plate C4, conductive plate C5 and conductive plate C6, conductive plate C7 and conductive plate C8), which can form four capacitors for corresponding to four load (lamp 92a, lamp 92b, lamp 92c, lamp 92d) respectively. Accordingly, the one-to-four transformer 94 and backlight apparatus 9 with the built-in protective capacitors are formed.

Compared with prior art, there are at least two conductive plates disposed within the bobbin of the transformer according to the embodiment of the backlight apparatus of the invention. The conductive plates are parallel-arranged and separated by a certain distance, such that a capacitance effect exists between the pair of conductive plates. The conductive plates can be coupled to the high-voltage side of the transformer and can serve as the protective capacitor of the circuit of the backlight apparatus. Accordingly, the transformer and the backlight apparatus of the invention can be implemented with this low-cost and compact-sized circuit structure.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A transformer suitable for a backlight module, the transformer comprising:
a bobbin having a high-voltage winding region and a first pin thereon, the high-voltage winding region having a first separation plate, the first pin being coupled to a first lamp of the backlight module;
a secondary winding wound on the high-voltage winding region, one end of the secondary winding being electrically connected to the first pin;
a first conductive plate disposed within the first separation plate, the first conductive plate being electrically connected to the first pin; and
a second conductive plate disposed within the first separation plate, the second conductive plate being located corresponding to the first conductive plate, such that the first conductive plate and the second conductive plate form a first capacitor.

2. The transformer of claim 1, wherein the bobbin further comprises a second pin, the second conductive plate being electrically connected with the second pin, the second pin being coupled to a passive component and a protective feedback circuit of the backlight module.

3. The transformer of claim 1, further comprising a third conductive plate and a fourth conductive plate, the bobbin further comprising a third pin, the third pin being electrically connected with another end of the secondary winding, the third pin being coupled to a second lamp of the backlight module, the high-voltage winding region further having a second separation plate, the third conductive plate being disposed within the second separation plate, the third conductive plate being electrically connected to the third pin, the fourth conductive plate disposed within the second separation plate, the fourth conductive plate being located corresponding to the third conductive plate, such that the third conductive plate and the fourth conductive plate form a second capacitor.

4. The transformer of claim 3, wherein the bobbin further comprises a fourth pin, the fourth conductive plate being electrically connected with the fourth pin, the fourth pin being coupled to a passive component and a protective feedback circuit of the backlight module.

5. A transformer suitable for a backlight module, the transformer comprising:
a bobbin having a first high-voltage winding region, a second high-voltage winding region, a first pin and a second pin thereon, the first high-voltage winding region having a first separation plate, the second high-voltage winding region having a second separation plate, the first pin being coupled to a first lamp of the backlight module, the second pin being coupled to a second lamp of the backlight module;
a first secondary winding wound on the first high-voltage winding region, one end of the first secondary winding being electrically connected to the first pin;
a second secondary winding wound on the second high-voltage winding region, one end of the second secondary winding being electrically connected to the second pin;
a first conductive plate disposed within the first separation plate, the first conductive plate being electrically connected to the first pin;
a second conductive plate disposed within the first separation plate, the second conductive plate being located corresponding to the first conductive plate, such that the first conductive plate and the second conductive plate form a first capacitor;
a third conductive plate disposed within the second separation plate, the third conductive plate being electrically connected to the second pin; and
a fourth conductive plate disposed within the second separation plate, the fourth conductive plate being located corresponding to the third conductive plate, such that the third conductive plate and the fourth conductive plate form a second capacitor.

6. The transformer of claim 5, wherein the bobbin further comprises a third pin and a fourth pin, the second conductive plate being electrically connected with the third pin, the third pin being coupled to a first passive component and a first protective feedback circuit of the backlight module, the fourth conductive plate being electrically connected with the fourth pin, the fourth pin being coupled to a second passive component and a second protective feedback circuit of the backlight module.

7. The transformer of claim 5, further comprising a fifth conductive plate, a sixth conductive plate, a seventh conductive plate and a eighth conductive plate, the bobbin further comprising a third pin and a fourth pin, the third pin being electrically connected with another end of the first secondary winding, the third pin being coupled to a third lamp of the backlight module, the fourth pin being electrically connected with another end of the second secondary winding, the fourth pin being coupled to a fourth lamp of the backlight module, the first high-voltage winding region further having a third separation plate, the second high-voltage winding region further having a fourth separation plate, the fifth conductive plate being disposed within the third separation plate, the fifth conductive plate being electrically connected to the third pin, the sixth conductive plate disposed within the third separation plate, the sixth conductive plate being located corresponding to the fifth conductive plate, such that the fifth conductive plate and the sixth conductive plate form a third capacitor, the seventh conductive plate being disposed within the fourth separation plate, the fifth conductive plate being electrically connected to the fourth pin, the eighth conductive plate disposed within the fourth separation plate, the eighth conductive plate being located corresponding to the seventh conductive plate, such that the seventh conductive plate and the eighth conductive plate form a fourth capacitor.

8. The transformer of claim 7, wherein the bobbin further comprises a fifth pin and a sixth pin, the sixth conductive plate being electrically connected with the fifth pin, the fifth pin being coupled to a first passive component and a first protective feedback circuit of the backlight module, the eighth conductive plate being electrically connected with the sixth pin, the sixth pin being coupled to a second passive component and a second protective feedback circuit of the backlight module.

9. A backlight apparatus comprising:
a power module;
a first lamp; and
a transformer comprising:
a bobbin having a low-voltage winding region, a high-voltage winding region and a first pin thereon, the high-voltage winding region having a first separation plate, the first pin being coupled to the first lamp;
a primary winding wound on the low-voltage winding region, the primary winding being coupled to the power module;
a secondary winding wound on the high-voltage winding region, one end of the secondary winding being electrically connected to the first pin;
a first conductive plate disposed within the first separation plate, the first conductive plate being electrically connected to the first pin; and
a second conductive plate disposed within the first separation plate, the second conductive plate being located corresponding to the first conductive plate, such that the first conductive plate and the second conductive plate form a first capacitor.

10. The backlight apparatus of claim 9, wherein the bobbin further comprises a second pin, the second conductive plate being electrically connected with the second pin, the second pin being coupled to a passive component and a protective feedback circuit.

11. The backlight apparatus of claim 9, wherein the backlight apparatus further comprises a second lamp, the transformer further comprising a third conductive plate and a fourth conductive plate, the bobbin further comprising a third pin, the third pin being electrically connected with another end of the secondary winding, the third pin being coupled to the second lamp, the high-voltage winding region further having a second separation plate, the third conductive plate being disposed within the second separation plate, the third conductive plate being electrically connected to the third pin, the fourth conductive plate disposed within the second separation plate, the fourth conductive plate being located corresponding to the third conductive plate, such that the third conductive plate and the fourth conductive plate form a second capacitor.

12. The backlight apparatus of claim 11, wherein the bobbin further comprises a fourth pin, the fourth conductive plate being electrically connected with the fourth pin, the fourth pin being coupled to a passive component and a protective feedback circuit.

13. A backlight apparatus comprising:
a power module;
a first lamp;
a second lamp; and
a transformer comprising:
a bobbin having a low-voltage winding region, a first high-voltage winding region, a second high-voltage winding region, a first pin and a second pin thereon, the first high-voltage winding region having a first separation plate, the second high-voltage winding region having a second separation plate, the first pin being coupled to the first lamp, the second pin being coupled to the second lamp;
a primary winding wound on the low-voltage winding region, the primary winding being coupled to the power module;
a first secondary winding wound on the first high-voltage winding region, one end of the first secondary winding being electrically connected to the first pin;
a second secondary winding wound on the second high-voltage winding region, one end of the second secondary winding being electrically connected to the second pin;
a first conductive plate disposed within the first separation plate, the first conductive plate being electrically connected to the first pin;
a second conductive plate disposed within the first separation plate, the second conductive plate being located corresponding to the first conductive plate, such that the first conductive plate and the second conductive plate form a first capacitor;
a third conductive plate disposed within the second separation plate, the third conductive plate being electrically connected to the second pin; and
a fourth conductive plate disposed within the second separation plate, the fourth conductive plate being located corresponding to the third conductive plate, such that the third conductive plate and the fourth conductive plate form a second capacitor.

14. The backlight apparatus of claim 13, wherein the bobbin further comprises a third pin and a fourth pin, the second conductive plate being electrically connected with the third pin, the third pin being coupled to a first passive component and a first protective feedback circuit, the fourth conductive plate being electrically connected with the fourth pin, the fourth pin being coupled to a second passive component and a second protective feedback circuit.

15. The backlight apparatus of claim 13, wherein the backlight apparatus further comprises a third lamp and a fourth lamp, the transformer further comprising a fifth conductive plate, a sixth conductive plate, a seventh conductive plate and a eighth conductive plate, the bobbin further comprising a third pin and a fourth pin, the third pin being electrically connected with another end of the first secondary winding, the third pin being coupled to the third lamp, the fourth pin being electrically connected with another end of the second secondary winding, the fourth pin being coupled to the fourth lamp, the first high-voltage winding region further having a third separation plate, the second high-voltage winding region further having a fourth separation plate, the fifth conductive plate being disposed within the third separation plate, the fifth conductive plate being electrically connected to the third pin, the sixth conductive plate disposed within the third separation plate, the sixth conductive plate being located corresponding to the fifth conductive plate, such that the fifth conductive plate and the sixth conductive plate form a third capacitor, the seventh conductive plate being disposed within the fourth separation plate, the fifth conductive plate being electrically connected to the fourth pin, the eighth conductive plate disposed within the fourth separation plate, the eighth conductive plate being located corresponding to the seventh conductive plate, such that the seventh conductive plate and the eighth conductive plate form a fourth capacitor.

16. The backlight apparatus of claim 15, wherein the bobbin further comprises a fifth pin and a sixth pin, the sixth conductive plate being electrically connected with the fifth pin, the fifth pin being coupled to a first passive component and a first protective feedback circuit, the eighth conductive plate being electrically connected with the sixth pin, the sixth pin being coupled to a second passive component and a second protective feedback circuit.
